(19) United States
(12) Patent Application Publication
(10) Pub. No.: US 2021/0213704 A1
(43) Pub. Date: Jul. 15, 2021

(54) SHEET MEMBER

(71) Applicant: Takahiko Tsurumaki, Gosen-shi, Niigata (JP)

(72) Inventor: Takahiko Tsurumaki, Gosen-shi, Niigata (JP)

(21) Appl. No.: 16/769,167

(22) PCT Filed: Dec. 19, 2017
(86) PCT No.: PCT/JP2017/045483

§ 371 Date: Jun. 2, 2020

(51) Int. Cl. B32B 7/023; B32B 38/00; B32B 27/08; B32B 27/20

(52) U.S. Cl. CPC B32B 7/023; B32B 38/145; B32B 27/08; B32B 27/20; B32B 2551/00; B32B 2307/408; B32B 2307/412; B32B 2307/414; B32B 2307/422; B32B 2307/409

(57) ABSTRACT

A sheet member includes a transmissive member, a white member, and a phosphorescent part. The transmissive member is a sheet-shaped member with a transmissive property. The white member is a white sheet-shaped member arranged so as to overlap the transmissive member. The phosphorescent part is provided between the transmissive member and the white member and contains a phosphorescent material.

### TECHNICAL FIELD

The present disclosure relates to a sheet comprising a phosphorescent material.

### BACKGROUND ART

Conventionally, a printing technology has been proposed in which an ink including a phosphorescent material is used as shown in Patent Document 1.

### PRIOR ART DOCUMENTS

### Patent Documents

Patent Document 1: Japanese Unexamined Patent Application Publication No. 2004-167889

### SUMMARY OF THE INVENTION

### Problems to be Solved by the Invention

There is a demand that characters and the like printed with an ink containing a phosphorescent material be less visible in a bright environment but that shapes of the prints be visible in a dim environment. However, the phosphorescent material itself has a color. Specifically, strontium aluminate is white. Thus, printing with the ink containing the phosphorescent material makes the printed area different in color from nearby areas. This results in a problem that causes the characters and the like to be visible also in the bright environment.

In the present disclosure, it is preferable to provide a technique in which presence of a phosphorescent material is less recognizable in a bright environment.

### Means for Solving the Problems

In a first aspect of the invention of the present disclosure, a sheet member comprises a transmissive member, a white member, and a phosphorescent part. The transmissive member is a sheet-shaped member with a transmissive property. The white member is a white sheet-shaped member and arranged so as to overlap the transmissive member. The phosphorescent part is provided between the transmissive member and the white member, and contains a phosphorescent material.

In such a configuration, when the sheet member is viewed from a side of the transmissive member, the white member makes the phosphorescent material inconspicuous. This enables presence of the phosphorescent material to be less recognizable to a viewer of the sheet member in a bright environment.

In the above-described sheet member, unevenness may be formed on a surface of the transmissive member opposite to a surface thereof where the white member is arranged.

Formation of the unevenness on the transmissive member results in reduction in clarity of a boundary part between where the phosphorescent part is provided and an area where the phosphorescent part is not provided. This enables presence of the phosphorescent material in the sheet member to be much less recognizable to a user more sophisticatedly.

Further, for the above-described sheet member, any one of matte coating, white coating, and luster processing may be applied to the surface of the transmissive member opposite to the surface thereof where the white member is arranged.

Matte coating or white coating to the transmissive member reduces clarity of the boundary part between the area where the phosphorescent part is provided and the area where the phosphorescent part is not provided. Further, by performing the luster processing to the transmissive member, the transmissive member as a whole becomes noticeable to the viewer of the sheet member. Furthermore, reflecting light intensively makes changes in color caused by the phosphorescent material inconspicuous. Accordingly, the coatings and processing enable presence of the phosphorescent material in the sheet member to be less recognizable to a user more sophisticatedly.

Further, in the above-described sheet member, the white member may comprise any one of a milky-white film, a pearly film, and Western paper. Such a white member itself has a color similar to that of the phosphorescent material, thereby enabling the phosphorescent material to be inconspicuous more sophisticatedly.

In a second aspect of the invention of the present disclosure, a sheet member comprises a first member, a second member, a phosphorescent part, and a white part. The first member is a sheet-shaped member with a transmissive property. The second member is a sheet-shaped member arranged so as to overlap the first member. The phosphorescent part is provided between the first member and the second member, and contains a phosphorescent material. The white part is provided in a partial area of a surface of the second member.

Further, the phosphorescent part is provided in a partial area of the sheet member, and the white part is provided such that at least a partial area of the white part overlaps at least a partial area of the phosphorescent part.

In such a configuration, when the phosphorescent part is viewed through the first member with the transmissive property, the white part makes the phosphorescent inconspicuous. This enables presence of the phosphorescent material to be less recognizable to a viewer of the sheet member in a bright environment.

In the above-described sheet members of the first and second aspects of the present disclosure, the phosphorescent part may constitute any of a character, a number, a sign, a graphic symbol, a mark, and a pattern, or a combination thereof.

In such configurations, the phosphorescent part not only emits light, but also has a shape meaning something, thereby enabling information to be provided for the viewer of the sheet member.

### BRIEF DESCRIPTION OF THE DRAWINGS

FIG. 1 is a side sectional view showing a sheet member of a first embodiment.

FIG. 2 is a plan view showing the sheet member of the first embodiment.

FIG. 3 is a diagram explaining a production process of the sheet member of the first embodiment.

FIG. 4 is a side sectional view showing a sheet member of a second embodiment.

FIG. 5 is a plan view showing the sheet member of the second embodiment.

FIG. 6 is a side sectional view showing a sheet member of a third embodiment.

FIG. 7 is a plan view showing the sheet member of the third embodiment.

FIG. 8 is a side sectional view showing a sheet member of a fourth embodiment.

FIG. 9 is a plan view showing the sheet member of the fourth embodiment.

FIG. 10 is a side sectional view showing a modified example of the sheet member of the fourth embodiment.

FIG. 11 is a side sectional view showing a modified example of the sheet member.

### EXPLANATION OF REFERENCE NUMERALS

101 . . . sheet member, 111 . . . transmissive member, 112 . . . white member, 113 . . . phosphorescent part, 201 . . . sheet member, 211 . . . transmissive member, 212 . . . white member, 213 . . . phosphorescent part, 221 . . . unevenly shaped portion, 301 . . . sheet member, 301A . . . sheet member, 311 . . . transmissive member, 312 . . . white member, 313 . . . phosphorescent part, 321 . . . coating layer, 321A . . . reflection layer, 401 . . . sheet member, 411 . . . first member, 412 . . . second member, 413 . . . phosphorescent part, 414 . . . white part.

### MODE FOR CARRYING OUT THE INVENTION

Embodiments of the present disclosure will be described hereinafter with reference to the accompanying drawings. It is to be understood that each embodiment described below is merely one form of the present disclosure, and that the present disclosure is not limited to the embodiments but may be implemented in various forms within the technical scope of the present disclosure.

### 1. First Embodiment

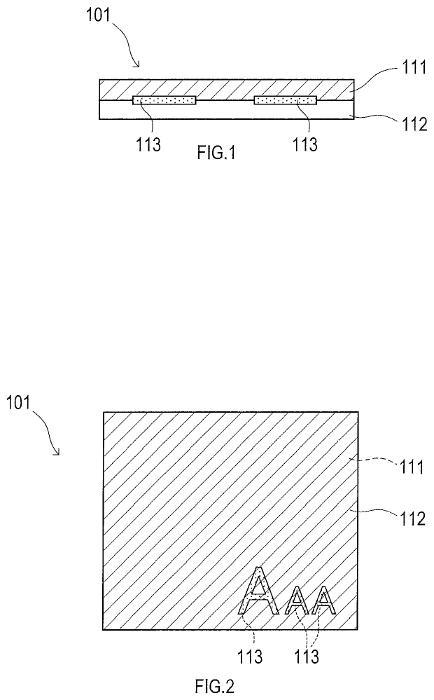

FIG. 1 shows a sheet member 101 of a first embodiment. In FIG. 1, a configuration of the sheet member 101 is schematically illustrated, and thus its exact arrangement, shape, ratio of sizes, and so on may be different from those of the actual one. The same applies to FIG. 2 and the subsequent figures.

The sheet member is in a shape having a small thickness and a specified area. In other words, the shape of the sheet member is similar to that of paper, cloth, or a plastic film.

### 1-1. Configuration of Sheet Member

The sheet member 101 shown in FIG. 1 comprises a transmissive member 111, a white member 112, and a phosphorescent part 113. The transmissive member 111 and the white member 112 are arranged in an overlapped manner. The phosphorescent part 113 is provided between the transmissive member 111 and the white member 112.

### 1-2. Transmissive Member

The transmissive member 111 is a sheet-shaped member with a light transmissive property. For example, the transmissive member 111 may have such a degree of transmissivity that allows light emitted from a below-described phosphorescent material to be visible through the transmissive member 111.

For materials for the transmissive member 111, for example, transparent or translucent thin plate-shaped resin or glass may be employed. Specifically, examples of the materials for the transmissive member 111 may include polypropylene, polyethylene, polyester, nylon, vinyl chloride, polycarbonate, polyvinyl alcohol, acrylic, cellophane, polystyrene, and Japanese paper.

### 1-3. White Member

The white member 112 is a white sheet-shaped member, which may or may not have the light transmissive property.

Materials for the white member 112 may include, for example, milky-white film, pearly film, and Western paper. It is to be noted that the materials for the white member 112 are not limited to the above-mentioned ones, as long as the member is white and sheet-shaped.

The milky-white film is a film having a milky white color.

The pearly film is a film containing a pearl pigment, or a film made by producing foam therein to have a pearl-like appearance. The pearl pigment is a pigment to provide a film with pearly luster. For example, mica particles coated with titanium dioxide may be the pearl pigment. However, the pearl pigment is not limited to this example. A variety of pigments capable of utilizing multiple reflection and/or interference phenomenon of light may be used as the pearl pigment.

The Western paper means general paper having flexibility. For example, the Western paper includes newsprint paper, printing and communication paper, wrapping paper, sanitary paper, and miscellaneous paper. Also, the Western paper may be explained as paper produced by a Western method, for example.

### 1-4. Phosphorescent Part

The phosphorescent part 113 has a shape having a small thickness and an area, and forms layers together with the transmissive member 111 and the white member 112. The phosphorescent part 113 comprises the phosphorescent material and a retaining material to retain the phosphorescent material.

The phosphorescent material is a material that stores light, such as visible light and UV light, and electromagnetic waves, and that has a light emitting property. For example, phosphorescent materials obtained by adding materials for changing a light emitting state, such as cerium, europium, neodymium and dysprosium, to strontium aluminate (such as SrAl₂O₄) as a main material may be used. However, the phosphorescent materials are not limited to these. The above-described phosphorescent materials are white.

The retaining material is a material that retains the phosphorescent material, and that has a light transmissive property to allow the phosphorescent material to store light and to emit light. Examples of the retaining materials may include gloss varnish, matt varnish, abrasion-resistant varnish, antistatic varnish, anti-blocking varnish, drying oil, paints, and adhesives.

### 1-5. Shape and Arrangement of Phosphorescent Part

As shown in FIG. 2, the phosphorescent part 113 is provided in a partial area of the sheet member 101. More specifically, the phosphorescent part 113 constitutes characters “AAA”.

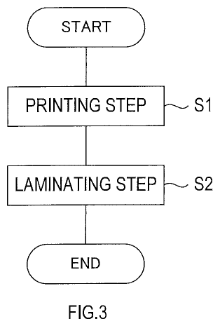

There is no particular limitation to a production method of the sheet member 101 described above. For example, as shown in FIG. 3, the sheet member 101 can be produced by two or more steps including a printing step S1 of forming the phosphorescent part 113 on the white member 112 by printing, and a laminating step S2 of laminating the transmissive member 111 to the white member 112. In the printing step, the phosphorescent part 113 may be firstly formed on the transmissive member 111. In this case, the transmissive member 111 and the white member 112 may be subsequently laminated to each other. Further, without the step of forming the phosphorescent part 113 by printing, the transmissive member 111, the white member 112, and the phosphorescent part 113, which are each prepared in advance, may be sequentially laminated to each other to produce the sheet member 101.

### 1-6. Effects

According to the above detailed first embodiment, the following effects can be obtained.

The transmissive member 111 of the sheet member 101 has a transmissive property, and thus the phosphorescent part 113 can be visually perceived by a viewer of the sheet member 101 from a side of the transmissive member 111.

The phosphorescent part 113 is slightly white because of presence of the phosphorescent material, and its color is similar to that of the white member 112 therebehind. Thus, the phosphorescent part 113 is less likely to be visually perceived by the viewer of the sheet member 101 in a bright environment. Accordingly, when the phosphorescent part 113 emits light in a dark environment to thereby become likely to be visible clearly, the sheet member 101 can give a surprise to a viewer of the emitted light.

The phosphorescent part 113 may be provided in the partial area of the sheet member 101 as in the present first embodiment, or may be provided in an area similar to that where the transmissive member 111 or the white member 112 is provided, as long as the phosphorescent part 113 has an area.

### 2. Second Embodiment

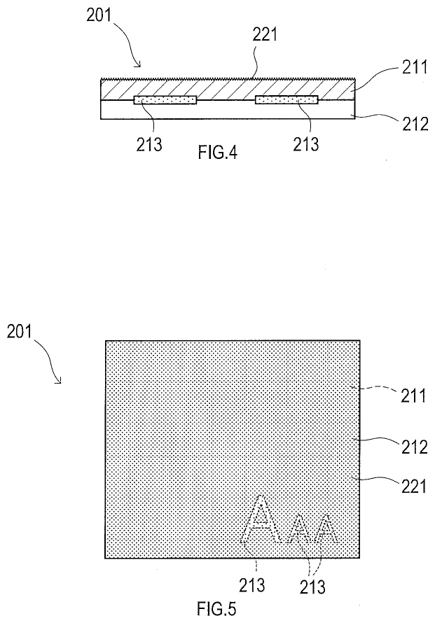

FIG. 4 shows a sheet member of a second embodiment.

### 2-1. Configuration of Sheet Member

A sheet member 201 shown in FIG. 4 comprises a transmissive member 211, a white member 212, and a phosphorescent part 213. The transmissive member 211 and the white member 212 are arranged in an overlapped manner. The phosphorescent part 213 is provided between the transmissive member 211 and the white member 212.

The white member 212 and the phosphorescent part 213 are similar to the white member 112 and the phosphorescent part 113 of the first embodiment, and thus the explanation is not repeated. The transmissive member 211 will be explained in detail.

### 2-2. Transmissive Member

For the transmissive member 211, a composition similar to that of the transmissive member 111 of the first embodiment may be basically employed. However, the transmissive member 211 differs from the transmissive member 111 in that an unevenly shaped portion 221 having fine unevenness is formed on at least one surface of the transmissive member 211.

The unevenly shaped portion 221 is formed by, what is called, embossing, matting, satin-finishing, graining, or other processing. That is, the transmissive member 211 corresponds to, what is called, an embossed film, a matted film, or a satin-finished film. The unevenly shaped portion 221 alters a surface texture of the transmissive member 111.

In the sheet member 201, the unevenly shaped portion 221 is formed on a surface of the transmissive member 211 opposite to a surface thereof where the white member 212 is arranged.

### 2-3. Shape and Arrangement of Phosphorescent Part

As shown in FIG. 5, the phosphorescent part 213 constitutes characters “AAA”. The transmissive member 211 has a transmissive property, and thus the phosphorescent part 213 can be visually perceived by a viewer of the sheet member 201 from a side of the transmissive member 211.

Further, the phosphorescent part 213 is slightly white because of presence of the phosphorescent material. However, the unevenly shaped portion 221 alters the surface texture of the transmissive member 211, thereby slightly decreasing the transmissive property of the transmissive member 211. Thus, the phosphorescent part 213 is less likely to be visually perceived by the viewer of the sheet member 201 in a bright environment.

There is no particular limitation to a production method of the sheet member 201 described above. For example, the sheet member 201 can be produced in a method similar to that of the sheet member 101 of the first embodiment. The transmissive member 211 may be produced by using a sheet with the unevenly shaped portion 221 formed in advance. Alternatively, the unevenly shaped portion 221 may be formed on the transmissive member 211 after the transmissive member 211 and the white member 212 are laminated to each other.

The unevenly shaped portion 221 may be provided all over the transmissive member 211 as in the present second embodiment, or may be provided in a partial area of the transmissive member 211, as long as the unevenly shaped portion 221 has an area.

### 2-4. Effects

According to the above detailed second embodiment, the following effects can be obtained.

In the sheet member 201, unevenly shaped portion 221 is formed on the transmissive member 211. This reduces clarity of a boundary part between an area where the phosphorescent part 213 is provided and an area where the phosphorescent part 213 is not provided, and thus presence of the phosphorescent material in the sheet member 201 can be less recognizable to a user. If the unevenly shaped portion 221 is provided in the partial area of the transmissive member 211, it is conceivable that the unevenly shaped portion 221 may be provided so as to cover at least part of the above-described boundary part. Such a configuration reduces the clarity of the above-described boundary part.

### 3. Third Embodiment

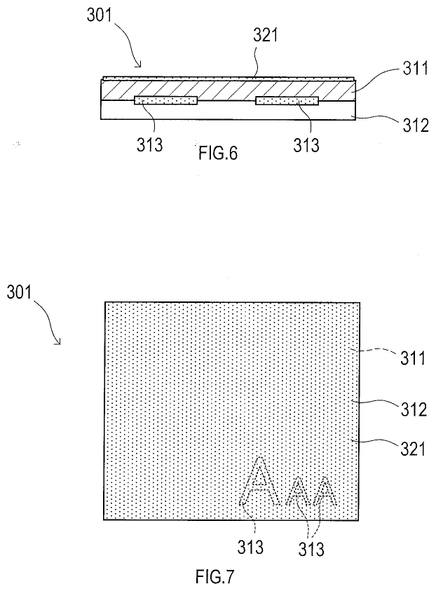

FIG. 6 shows a sheet member of a third embodiment.

### 3-1. Configuration of Sheet Member

A sheet member 301 shown in FIG. 6 comprises a transmissive member 311, a white member 312, and a phosphorescent part 313. The transmissive member 311 and the white member 312 are arranged in an overlapped manner. The phosphorescent part 313 is provided between the transmissive member 311 and the white member 312.

The white member 312 and the phosphorescent part 313 are similar to those of the white member 112 and the phosphorescent part 113 of the first embodiment, and thus the explanation is not repeated. The transmissive member 311 is explained in detail.

### 3-2. Transmissive Member

For the transmissive member 311, a composition similar to that of the transmissive member 111 of the first embodiment may be basically employed. However, the transmissive member 311 differs from the transmissive member 111 in that a coating layer 321 is formed on a surface of the transmissive member 311.

The coating layer 321 is a layer formed by matte coating or white coating. The matte coating corresponds to, for example, a coating that provides a coating film surface with roughness, or a coating with a paint providing highly diffused reflection of light, which paint contains fine particles and the like appropriately added for exerting such a function. Here, a general matte paint may be used. The white coating is a coating with a paint containing a white pigment.

### 3-3. Shape and Arrangement of Phosphorescent Part

As shown in FIG. 7, the phosphorescent part 313 constitutes characters “AAA”. The transmissive member 211 has a transmissive property, and thus the phosphorescent part 313 can be visually perceived by a viewer of the sheet member 301 from a side of the transmissive member 311.

Further, the phosphorescent part 313 is slightly white because of the phosphorescent material. However, the coating layer 321 alters a surface color of the transmissive member 311, thereby slightly decreasing the transmissive property of the transmissive member 311. Thus, the phosphorescent part 313 is less visible in a bright environment.

In the sheet member 301, the coating layer 321 is formed on a surface of the transmissive member 311 opposite to a surface thereof where the white member 312 is arranged.

There is no particular limitation to a production method of the sheet member 301 described above. For example, the sheet member 301 can be produced in a method similar to that of the sheet member 101 of the first embodiment. On the transmissive member 311, the coating layer 321 may be formed by coating before the transmissive member 311 and the white member 312 are laminated to each other, or may be formed after the transmissive member 311 and the white member 312 are laminated to each other.

It is to be noted that the coating layer 321 may be provided all over the transmissive member 311 as in the present third embodiment, or may be provided in a partial area of the transmissive member 311, as long as the coating layer 321 has an area.

### 3-4. Effects

According to the above detailed third embodiment, the following effects can be obtained.

In the sheet member 301, the coating layer 321 is formed on the transmissive member 311. This reduces clarity of a boundary part between an area where the phosphorescent part 313 is provided and an area where the phosphorescent part 313 is not provided, and thus presence of the phosphorescent material in the sheet member 301 can be less recognizable to a user. If the coating layer 321 is provided in the partial area of the transmissive member 311, it is conceivable that the coating layer 321 may be provided so as to cover at least part of the above-described boundary part. Such a configuration reduces the clarity of the above-described boundary part.

### 4. Fourth Embodiment

FIG. 8 shows a sheet member 401 of a fourth embodiment.

### 4-1. Configuration of Sheet Member

The sheet member 401 shown in FIG. 8 comprises a first member 411, a second member 412, a phosphorescent part 413, and a white part 414. The first member 411 and the second member 412 are arranged in an overlapped manner. The phosphorescent part 413 is provided between the first member 411 and the second member 412.

Here, the first member 411 may be configured similarly to the transmissive member 111 of the first embodiment. Further, the phosphorescent part 413 may be configured similarly to the phosphorescent part 113 of the first embodiment.

The second member 412 is a sheet-shaped member, and the material, composition, color, pattern, surface shape, and so on thereof are not limited in particular.

The white part 414 is a layer formed by white coating. The white coating is a coating with a paint containing a white pigment.

### 4-2. Shape and Arrangement of Phosphorescent Part

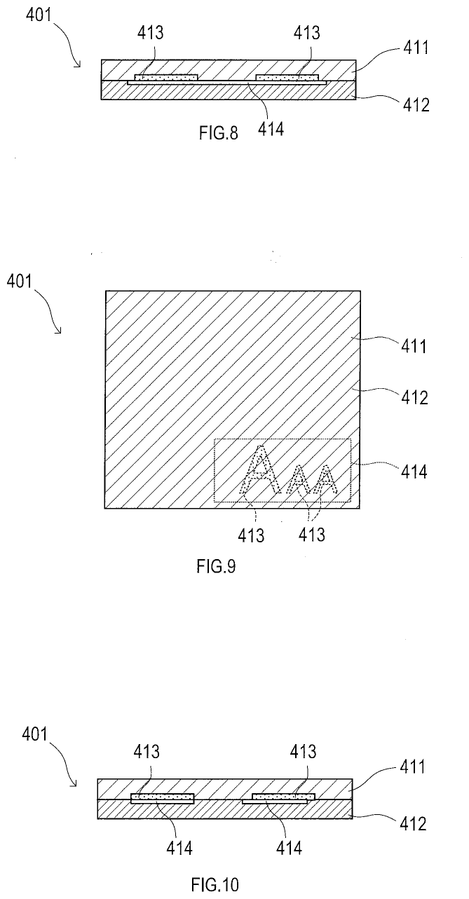

As shown in FIG. 9, the phosphorescent part 413 constitutes characters “AAA”.

The white part 414 is provided in a partial area of the second member 412. Further, the white part 414 is provided so as to overlap the phosphorescent part 413.

There is no particular limitation to a production method of the sheet member 401 described above. The sheet member 401 can be produced in a method similar to that of the sheet member 101 of the first embodiment. The white part 414 may be formed in advance by printing or the like on the second member 412.

### 4-3. Effects

According to the above detailed third embodiment, the following effects can be obtained.

The first member 411 of the sheet member 401 has a transmissive property, and thus the phosphorescent part 413 can be visually perceived by a viewer of the sheet member 401 from a side of the first member 411.

Further, when the sheet member 401 is viewed from the side of the first member 411, the white part 414 makes the phosphorescent material inconspicuous. This enables presence of the phosphorescent material to be less recognizable to a viewer of the sheet member 401 in a bright environment.

### 4-4. Modified Examples

FIG. 9 shows an example of a configuration in which the phosphorescent part 413 is formed in an area where the white part 414 is formed, but it is only required that the white part 414 is provided such that at least a part thereof overlaps at least a part of the phosphorescent part 413. For example, as shown in FIG. 10, the phosphorescent part 413 and the white part 414 may be formed in the same area with respect to an extending direction of the sheet member 401. Alternatively, the sheet member 401 may include an area where the white part 414 is not present but only the phosphorescent part 413 is present with respect to the extending direction.

### 5. Other Embodiments

Although embodiments of the present discloser have been described above, it is to be understood that the present disclosure is not limited to the above-described embodiments, but may be implemented in various forms within the technical scope of the present disclosure.

(5a) The respective materials for forming the above-described transmissive member, white member, phosphorescent part, first member, second member, and white part are not limited to the materials described in the aforementioned embodiments, and any adjustments, such as addition of other materials, may be made as appropriate.

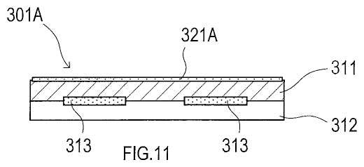

(5b) For the sheet member 301 of the third embodiment shown in FIG. 6, the layer formed by matte coating or white coating is shown as an example of the coating layer 321. However, instead of providing the coating layer 321, luster processing may be performed. Specifically, like a sheet member 301A shown in FIG. 11, a reflection layer 321A may be provided as a coating film, which has a transmissive property while reflecting light.

The reflection layer 321A can be formed by, for example, glass coating. The reflection layer 321A may be formed by application of high-gloss varnish or transparent paint.

By performing the luster processing to the transmissive member 311, the processed area intensively reflects light. This allows changes in color caused by the phosphorescent material to be inconspicuous.

(5c) In each of the aforementioned first to forth embodiments, the phosphorescent part constituting characters is illustrated. However, the shape of phosphorescent part is not limited to characters, but may be any of number, sign, graphic symbol, mark, and pattern, or may be configured with a combination thereof, including characters.

1. A sheet member comprising:
a transmissive member, which is a sheet-shaped member with a transmissive property;
a white member, which is a white sheet-shaped member and arranged so as to overlap the transmissive member; and
a phosphorescent part provided between the transmissive member and the white member and containing a phosphorescent material.

2. The sheet member according to claim 1,
wherein unevenness is formed on a surface of the transmissive member opposite to a surface thereof where the white member is arranged.

3. The sheet member according to claim 1,
wherein any one of matte coating, white coating, and luster processing is applied to a surface of the transmissive member opposite to a surface thereof where the white member is arranged.

4. The sheet member according to claim 1,
wherein the white member comprises any one of a milky-white film, a pearly film, and Western paper.

5. A sheet member comprising:
a first member, which is a sheet-shaped member with a transmissive property;
a second member, which is a sheet-shaped member arranged so as to overlap the first member;
a phosphorescent part provided between the first member and the second member and containing a phosphorescent material; and
a white part provided in a partial area of a surface of the second member,
wherein the phosphorescent part is provided in a partial area of the sheet member, and
wherein the white part is provided such that at least a portion of the white part overlaps at least a portion of the phosphorescent part.

6. The sheet member according to claim 1,
wherein the phosphorescent part constitutes any of a character, a number, a sign, a graphic symbol, a mark, and a pattern, or a combination thereof.

7. The sheet member according to claim 5,
wherein the phosphorescent part constitutes any of a character, a number, a sign, a graphic symbol, a mark, and a pattern, or a combination thereof.
